(19) United States
(12) Patent Application Publication
(10) Pub. No.: US 2018/0329174 A1
(43) Pub. Date: Nov. 15, 2018

(54) UPRIGHT MICROSCOPE

(71) Applicant: OLYMPUS CORPORATION, Tokyo (JP)

(72) Inventors: Yasuo FUNAKOSHI, Tokyo (JP); Takumi UMEMURA, Tokyo (JP); Tsuyoshi MOCHIZUKI, Tokyo (JP)

(73) Assignee: OLYMPUS CORPORATION, Tokyo (JP)

(21) Appl. No.: 16/043,087

(22) Filed: Jul. 23, 2018

Related U.S. Application Data
(63) Continuation of application No. PCT/JP2017/008505, filed on Mar. 3, 2017.

(30) Foreign Application Priority Data
Mar. 16, 2016 (JP) 2016-052757

(51) Int. Cl. G02B 7/16; G02B 21/24; G02B 21/02; G02B 21/26

(52) U.S. Cl. CPC G02B 7/16; G02B 21/26; G02B 21/02; G02B 21/248

(57) ABSTRACT

An upright microscope includes: a stage on which a specimen is placed; a revolver configured to hold a plurality of objective lenses and enable each objective lens on an observation optical axis to be switched by rotating an operation collar; a lens barrel including an optical system; a microscope body including a base, a stand that stands on a back side of the base and holds the stage, and an arm that is supported by the stand, extends toward a font side of the upright microscope, and includes a top part to which the lens barrel is attached and a bottom part to which the revolver is attached; and a finger hooking part that is positioned between the revolver and a lower part of the lens barrel and is for placing any of hand fingers other than a thumb of an observer when rotating the operation collar.

### CROSS-REFERENCE TO RELATED APPLICATION

This application is a continuation of PCT international application Ser. No. PCT/JP2017/008505 filed on Mar. 3, 2017 which designates the United States, incorporated herein by reference, and which claims the benefit of priority from Japanese Patent Applications No. 2016-052757, filed on Mar. 16, 2016, incorporated herein by reference.

### BACKGROUND

### 1. Technical Field

The present disclosure relates to an upright microscope.

### 2. Related Art

Upright microscopes are used in medicine and biology and other fields for study, examination and education (see Japanese Patent No. 3362892 and Japanese Patent No. 4221285). For examination, mainly, a large number of slide specimens may be enlarged and observed to be examined. When a slide specimen is examined, an objective lens with a low 4 to 10 times magnification is used and the slide specimen is observed while being moved with an X-Y handle of a stage on which the slide specimen is set. When there is something to note, such as an abnormality in tissues and cells serving as the specimen or bacteria, an operation collar of a revolver is rotated to switch from the low-magnification objective lens to an objective lens with an intermediate to high 20 to 100 times magnification and the specimen is observed.

In recent years, for functions of microscopes, there has been an increasing demand not only for clear observation images but also for operability of each component of the microscopes and reduction of tiredness associated with operations. Particularly for examination, the demand is increasing as a large number of slide specimens may be examined in a day.

### SUMMARY

In some embodiments, an upright microscope includes: a stage on which a specimen is placed; a revolver configured to hold a plurality of objective lenses and enable each objective lens on an observation optical axis to be switched by rotating an operation collar; a lens barrel including an optical system configured to cause light that is focused by the objective lens on the observation optical axis to be incident on eyepieces; a microscope body including a base, a stand that stands on a back side of the base and that holds the stage, and an arm that is supported by the stand, that extends toward a font side of the upright microscope, and that includes a top part to which the lens barrel is attached and a bottom part to which the revolver is attached; and a finger hooking part that is positioned between the revolver and a lower part of the lens barrel and that is for placing any of hand fingers other than a thumb of an observer when rotating the operation collar.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a side view illustrating a schematic configuration of an upright microscope according to a first embodiment of the disclosure;

FIG. 2 is a top view of the upright microscope in FIG. 1;

FIG. 3 is a perspective view of the upright microscope in FIG. 1 viewed from the upper right of the front;

FIG. 4 is an enlarged perspective view of a finger hooking part of the upright microscope in FIG. 1;

FIG. 5 is a diagram illustrating operations on the upright microscope in FIG. 1;

FIG. 6 is an enlarged perspective view of a finger hooking part of an upright microscope of Modification 1 of the first embodiment of the disclosure;

FIG. 7 is a diagram illustrating a finger hooking part according to Modification 2 of the first embodiment of the disclosure;

FIG. 8 is a side view of a vicinity of a revolver of an upright microscope according to Modification 3 of the first embodiment of the disclosure;

FIG. 9 is a side view of an upright microscope according to a second embodiment of the disclosure;

FIG. 10 is a side view of an exemplary upright microscope that is used conventionally; and

FIG. 11 is a diagram illustrating switching with the revolver of the microscope in FIG. 10.

### DETAILED DESCRIPTION

Upright microscopes according to embodiments of the disclosure will be described in detail below with reference to the accompanying drawings. Note that the embodiments do not limit the disclosure. Furthermore, the same parts are denoted with the same reference numerals to describe the drawings. Furthermore, the drawings are schematic only, and thus note that the relationship between the thickness and width of each member, the ratio of each member, etc., may be different from those of real ones. The drawings contain parts where the mutual sizes and ratios are different between the drawings.

### First Embodiment

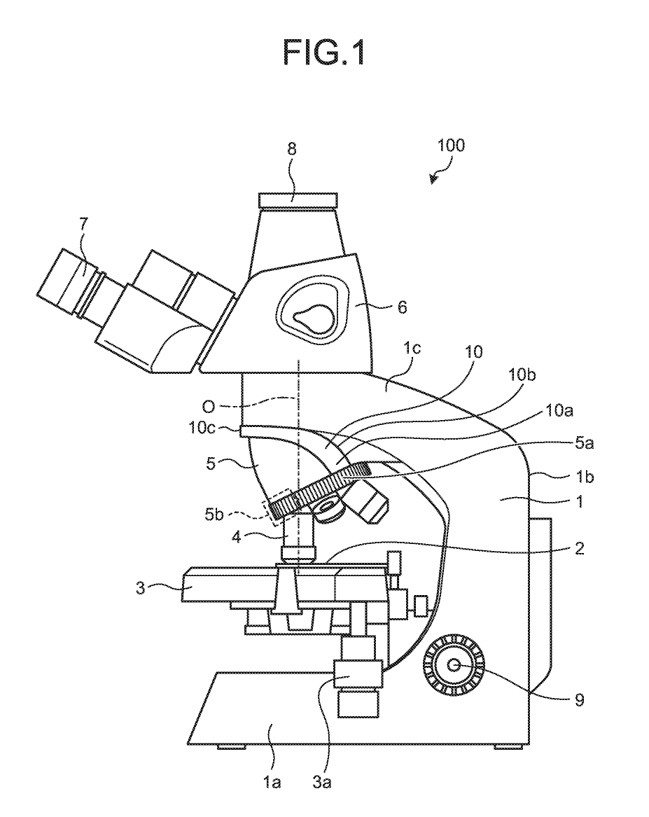

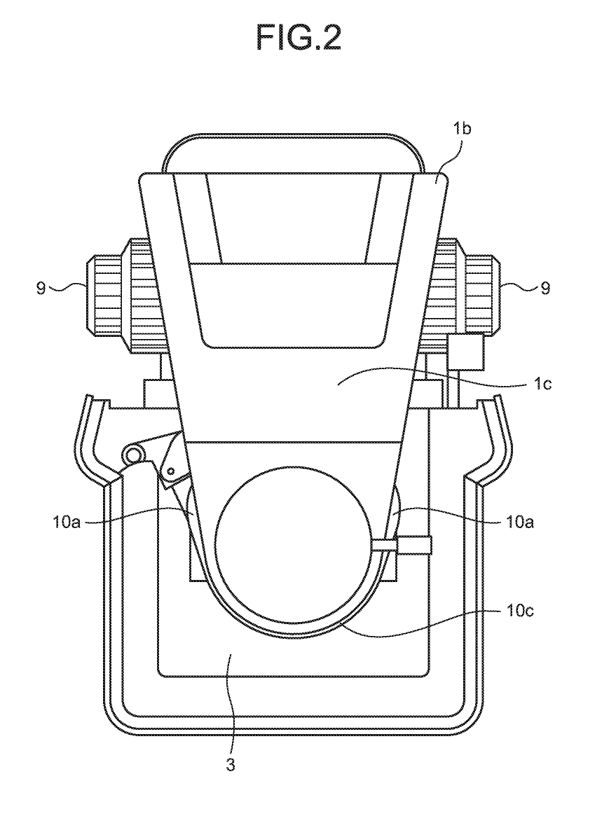

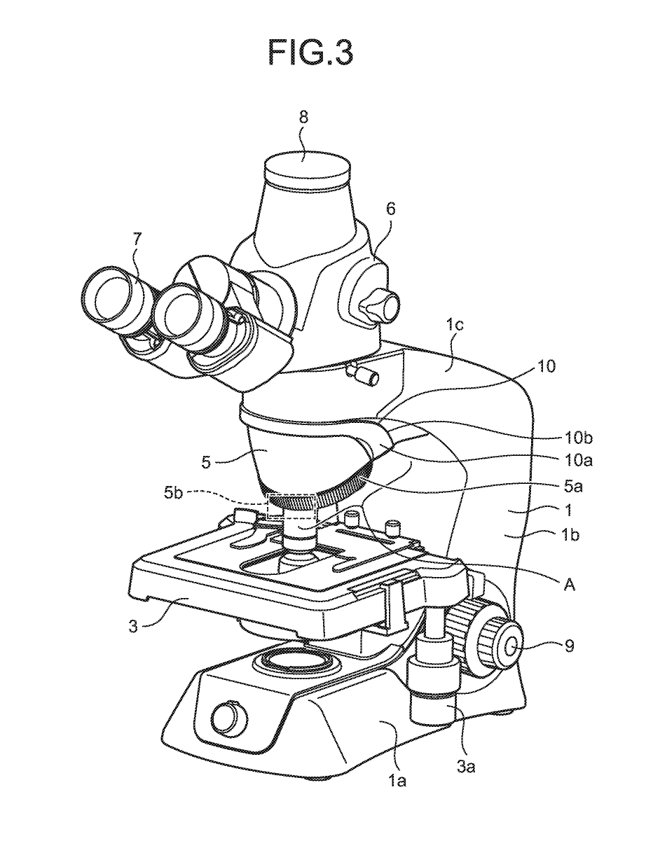

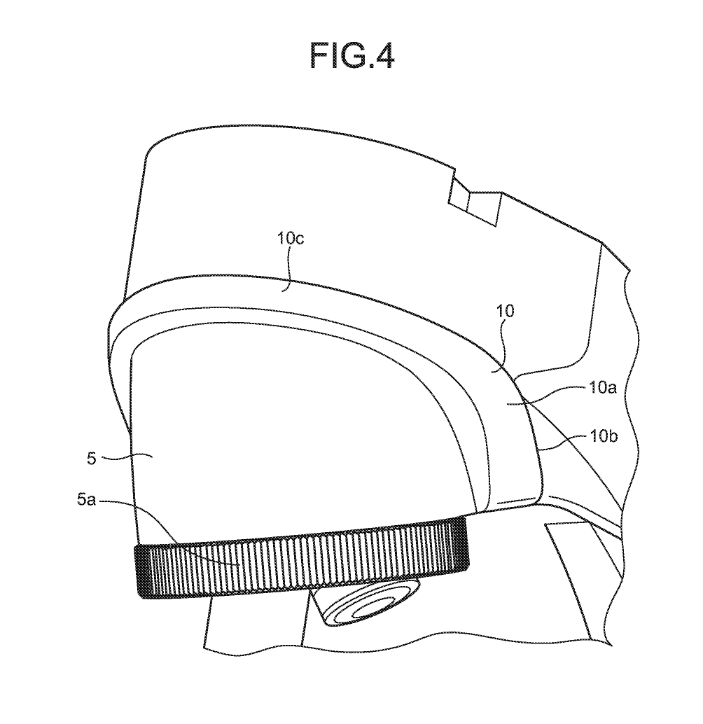

FIG. 1 is a side view illustrating a schematic configuration of an upright microscope according to a first embodiment of the disclosure. FIG. 2 is a top view of the upright microscope in FIG. 1. FIG. 3 is a perspective view of the upright microscope in FIG. 1 viewed from the upper right of the front. FIG. 4 is an enlarged perspective view of a finger hooking part of the upright microscope in FIG. 1. Herein, a side on which an observer is positioned for observation is defined as a front side of the upright microscope and a side opposed to the front will be defined as a back side of the upright microscope.

An upright microscope 100 includes a stage 3 on which a specimen 2 is placed, a revolver 5 that holds a plurality of objective lenses 4 and a lens barrel 6 that are provided on a microscope body 1. The microscope body 1 is a body that supports each component of the upright microscope 100 and consists of a combination of parts formed from aluminum alloy, etc., or formed of plastic materials. The microscope body 1 includes a base 1a in which an illuminating optical system (not shown) is provided, a stand 1b that holds the stage 3, and an arm 1c that is provided such that it extends from the stand 1b to the front side of the upright microscope 100 and holds the revolver 5 and the lens barrel 6.

An alignment mechanism (not shown) that is driven in association with an operation of rotating an alignment handle 9 that is provided such that it protrudes from the left and right side surfaces of the microscope body 1 causes the stage 3 on which the specimen 2 is placed to go up and down to adjust the focus. The stage 3 includes an X-Y handle 3a that enables flexible move of the specimen 2 within the X-Y plane.

The objective lenses 4 with different magnifications are detachably attached to the revolver 5. The revolver 5 of the first embodiment is an inward revolver that is attached to the bottom surface of the arm 1c such that the objective lenses 4 other than the objective lens 4 on an observation optical axis O directed to the back side. The revolver 5 has a cylindrical shape and includes an operation collar 5a whose outer circumference is knurled. An operation part 5b on which the observer puts the thumb is on the front side of the operation collar 5a.

The lens barrel 6 is detachably attached to the top surface of the arm 1c. On the lens barrel 6, two eyepieces. 7 and a television (TV) port 8 for attaching an imaging unit, such as a CCD camera, are provided. The lens barrel 6 incorporates an optical system (not shown) that causes light focused by the objective lens 4 on the observation optical axis O to be incident on the eyepieces 7 or the imaging unit. The lens barrel 6 is attached such that the eyepieces 7 are on the front side of the upright microscope 100 when observation is performed with the upright microscope 100, and the lens barrel 6 is rotatable and thus it is possible to rotate the lens barrel 6 to turn the eyepieces 7 to the back side of the upright microscope 100 to observe the specimen from the back side or to be housed.

A finger hooking part 10 is a part on which the observer places any of the hand fingers other than the thumb when rotating the operation collar 5a. The finger hooking part 10 is arranged between the revolver 5 above the operation collar 5a and the arm 1c, i.e., above the revolver 5 and on the back side. The finger hooking part 10 is arranged in a position such that, when the observer who is positioned on the front side of the upright microscope 100 places the thumb on the operation part 5b of the operation collar 5a, other fingers can be placed on the finger hooking part 10, for example, in a position such that the most distal part of the finger hooking part 10 is within 150 mm, preferably about 50 to 100 mm, from the operation part 5b.

The finger hooking part 10 includes a body part 10a that protrudes from the microscope body 1 and thus has a protruding shape and the back side of the body part 10a serves as a finger hook surface 10b. The length of protrusion of the finger hooking part 10 from the microscope body 1 is a length sufficient to hook other fingers, for example, 5 mm or larger. The finger hook surface 10b may have an irregular shape for positioning fingers when placing fingers other than the thumb. The finger hooking part 10 is provided on both the left and right sides of the microscope body 1 when viewed from the observer. The finger hooking part 10 that is provided on the left and right is formed in a way that the body part 10a is connected integrally with a circular part 10c. The finger hooking part 10 preferably be different in color from the microscope body 1 and the operation collar 5a. Coloring the finger hooking part 10 in a color different from those of the microscope body 1 and the operation collar 5a makes it possible to identify the finger hooking part 10 by color. As the microscope body 1 is colored in white and the operation collar 5a is colored in black in general, the finger hooking part 10 is colored in, for example, blue.

In general, in examination on the specimen 2 with a slide glass, the observer observes the specimen 2 according to the following operations.
(1) Operate the operation collar 5a of the revolver 5 to switch the objective lens 4 to one with a low (for example, 10 times) magnification.
(2) Set the specimen 2 on the upper surface of the stage 3.
(3) Operate the alignment handle 9 to bring the specimen 2 into focus.
(4) While observing the specimen 2 through the eyepieces 7, operate the X-Y handle 3a to move the stage in the X-Y direction to screen the specimen 2.
(5) When there is something to note on the specimen 2, operate the operation collar 5a to switch the objective lens 4 to one with an intermediate to high (for example, 40 times) magnification.
(6) Operate the alignment handle 9 to bring the specimen 2 into focus again.
(7) Observe the specimen 2 with the objective lens 4 with the intermediate to high magnification.
(8) Operate the operation collar 5a to switch the objective lens 4 to one with the low (for example, 10 times) magnification again and repeat from (4) again.

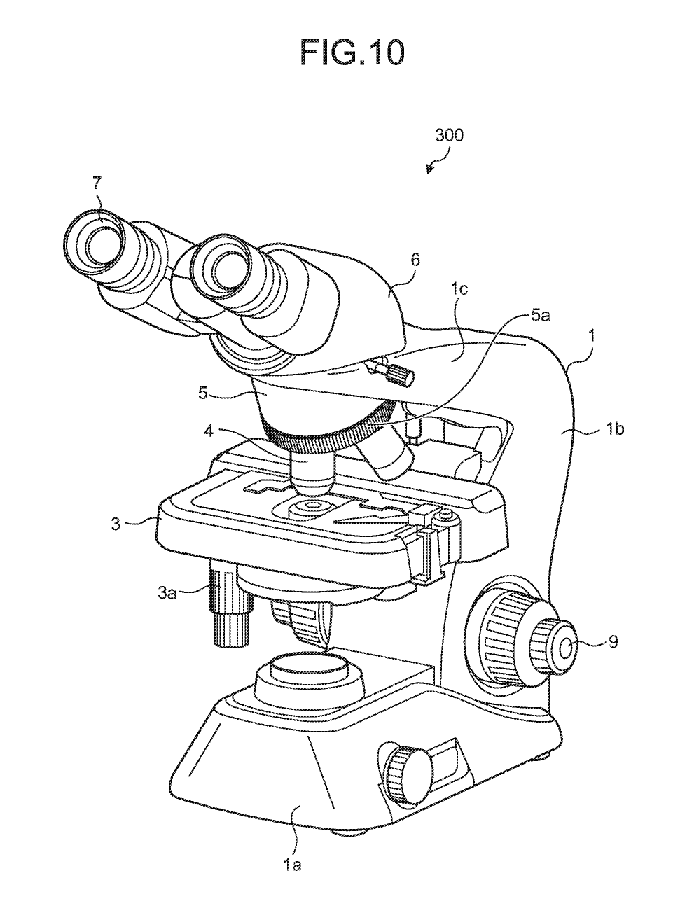

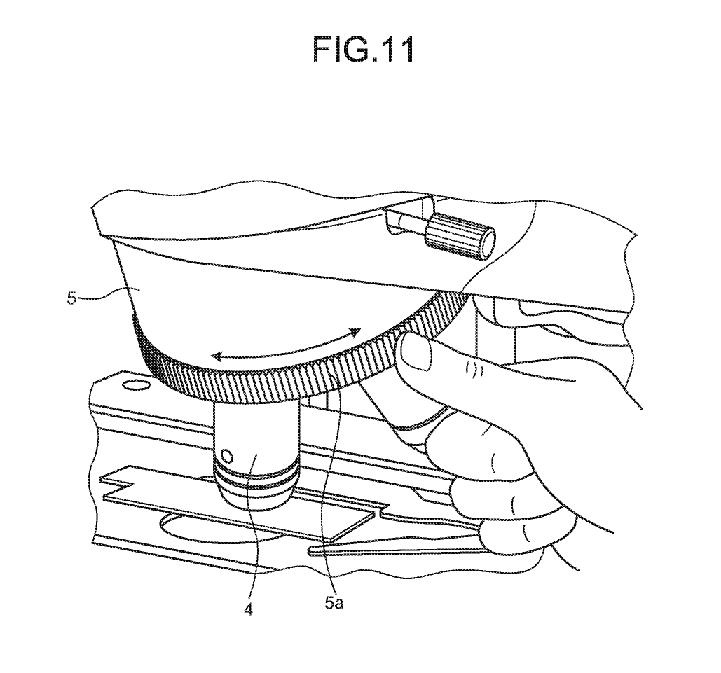

FIG. 10 is a side view of an exemplary upright microscope that is conventionally used. FIG. 11 is a diagram illustrating switching with the revolver of the microscope in FIG. 10. As illustrated in FIG. 10, the alignment handle 9 and the X-Y handle 3a are arranged in a lower position in an upright microscope 300, that is, a position close to the top surface of a desk on which the arm of the observer is placed. Accordingly, for focusing with the alignment handle 9 at (3) and (6) and the operation on the stage 3 in the X-Y direction with the X-Y handle 3a at (4) according to the examination procedure described above, the observer is able to perform the operations with the hand or arm being put on the desk and this enables stable operations and reduces tiredness associated with the operations.

On the other hand, the revolver 5 is arranged in a relatively high position in the upright microscope 300, that is, a position distant from the top surface of the desk on which the observer places the arm. Thus, for the operation of switching the objective lens 4 with the operation collar 5a at (1), (5) and (8) according to the above-described examination procedure, the thumb is placed on the front side of the operation collar 5a and other fingers are put on the back side of the operation collar 5a to rotate the operation collar 5a or, as illustrated in FIG. 11, only the thumb is placed on the operation collar 5a and the thumb is moved right and left to rotate the operation collar 5a. When the operation collar 5a is operated with the thumb and other fingers, the observer operates the operation collar 5a with the arm being lifted up and this increases tiredness. When the operation collar 5a is operated with only the thumb, the observer operates the operation collar 5a with the elbows being put on the desk and with the hands being lifted up and this reduces tiredness than when the operation collar 5a is operated with the arm being lifted up; however, as the revolver 5 employs a click mechanism, a fine operation not to go over a click at click-in is needed in a series of operations of click-out, sliding rotation and click-in.

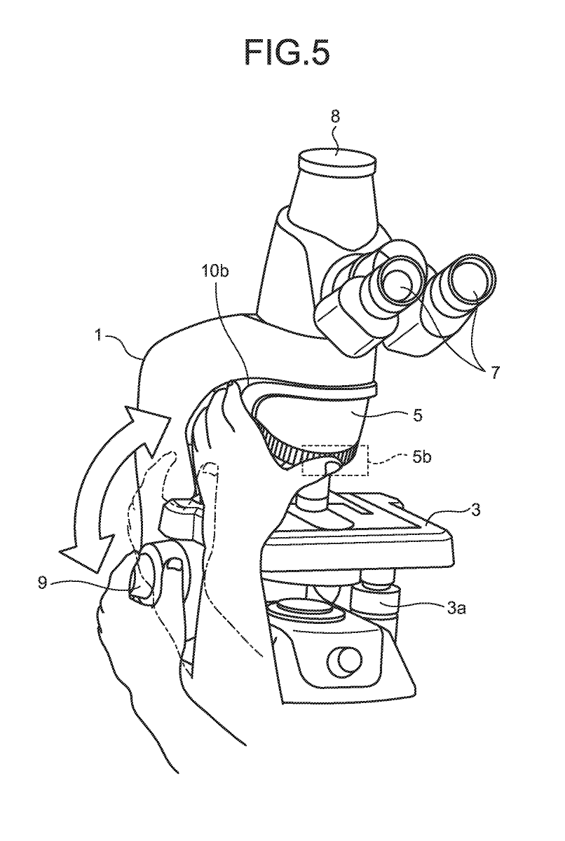

On the other hand, in the upright microscope 100 according to the first embodiment, as illustrated in FIG. 5, the finger hooking part 10 is arranged on the part of the microscope body 1 at which other fingers are positioned when the thumb is placed on the operation part 5b on the front side of the operation collar 5a with the elbow putting on the desk, that is, above and the back side of the revolver 5. Accordingly, it is possible to operate the operation collar 5a with the thumb and other fingers without fail while reducing tiredness of the observer. Furthermore, as illustrated in FIG. 5, the finger hooking part 10 is arranged in a position such that it is possible to operate the operation collar 5a and the alignment handle 9 by lifting up and down the front arm with the elbow putting on the desk and thus it is possible to easily perform an operation of bringing the specimen 2 into focus after switching the objective lens 4 with the operation collar 5a (the operations at (5) and (6) described above) while observing the specimen 2 via the eyepieces 7. Furthermore, the finger hooking part 10 protrudes from the microscope body 1 and is colored in a color different from that of the microscope body 1 and accordingly operations, particularly, blind operations are much easier relying on the shape and color.

The finger hooking part 10 of the first embodiment is arranged on both the left and right. Alternatively, the finger hooking part 10 may be formed on any one of the left and right when viewed from the observer.

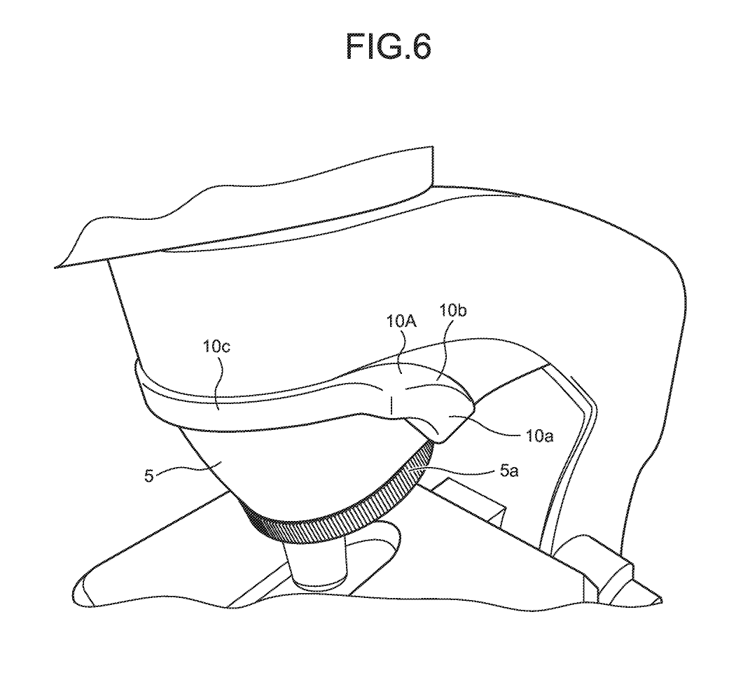

The body part 10a of the finger hooking part 10 has a gently protruding shape from the circular part 10c. Alternatively, as illustrated in FIG. 6, a finger hooking part 10A in which the body part 10a protrudes from the circular part 10c with degrees may be used.

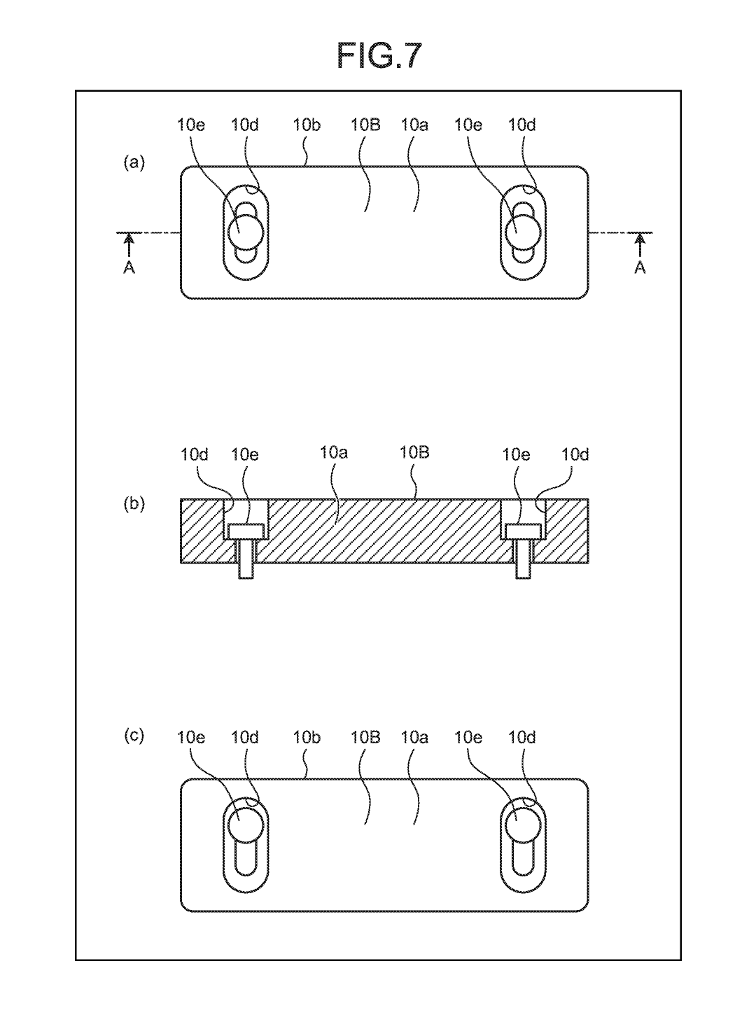

Furthermore, the finger hooking part 10 may be detachable from the microscope body 1. FIG. 7 is a diagram illustrating a finger hooking part 10B according to Modification 2 of the first embodiment of the disclosure. (a) of FIG. 7 is a top view of the finger hooking part 10B, (b) of FIG. 7 is a cross-sectional view taken along the line A-A in (a) of FIG. 7, and (c) of FIG. 7 is a top view of the finger hooking part 10B for which the position at which the finger hooking part 10B is attached to the microscope body 1 is changed.

The finger hooking part 10B has a shape of a rectangular plate and has long counterbores 10d at both ends of the body part 10a. Fixing screws 10e are screwed into the counterbores 10d to fix the finger hooking part 10B to the microscope body 1. The counterbores 10d are long holes that are long along the direction of the shorter sides of the finger hooking part 10B. By shifting the position at which the fixing screws 10e are fixed to the counterbores 10d as illustrated in (c) of FIG. 7, it is possible to change the positon at which the finger hooking part 10B is attached to the microscope body 1. By changing the position at which the finger hooking part 10B is attached to the microscope body 1, it is possible to change the distance from the operation part 5b of the operation collar 5a to the finger hook surface 10b of the finger hooking part 10B and accordingly the observer is able to arrange the finger hooking part 10B in a position where the observer operates the finger hooking part 10B easily.

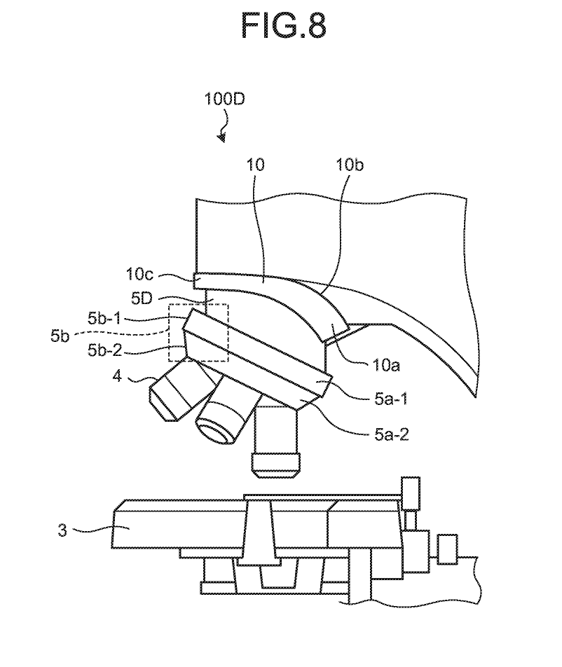

The first embodiment and Modification illustrate the case where an inward revolver is used. When an outward revolver is used, provision of a finger hooking part enables reduction of tiredness of the observer. FIG. 8 is a side view of a vicinity of a revolver of an upright microscope 100D according to Modification 3 of the first embodiment of the disclosure.

The upright microscope 100D includes an outward revolver 5D that is attached to the bottom surface of the arm 1c such that the objective lenses 4 other than the objective lens 4 on the observation optical axis O face the front side.

The operation collar 5a of the revolver 5D includes a cylindrical part 5a-1 that has a cylindrical shape on the side of the arm 1c and a conical part 5a-2 that has a conical trapezoidal shape on the side of the objective lenses 4. The outer circumferences of the cylindrical part 5a-1 and the conical part 5a-2 are knurled.

While placing the thumb on an operation part 5b-2 on the front side of the conical part 5a-2, the observer puts other fingers on the finger hook surface 10b of the finger hooking part 10 to rotate the operation collar 5a. As the conical part 5a-2 has a conical trapezoidal shape, the operation part 5b-2 on the front side is approximately vertical. This makes the operation of switching the objective lens 4 easy. While placing the thumb on an operation part 5b-1 on the front side of the cylindrical part 5a-1, the observer may place other fingers on the back side of the cylindrical part 5a-1 to rotate the operation collar 5a.

### Second Embodiment

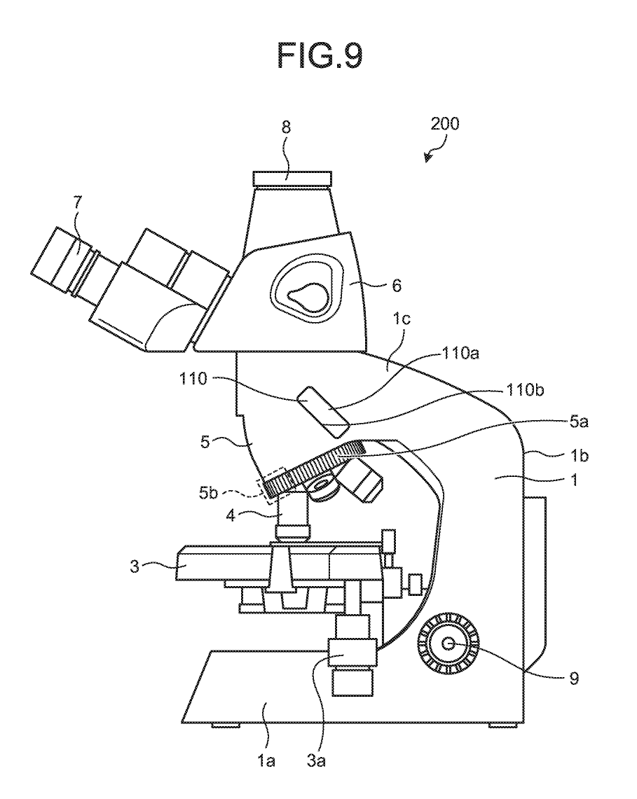

An upright microscope according to a second embodiment includes a finger hooking part that is concave from a microscope body and thus has a concave shape. FIG. 9 is a side view of an upright microscope 200 according to the second embodiment of the disclosure.

The upright microscope 200 includes a finger hooking part 110 on a part on which an observer places any of the hand fingers other than the thumb when rotating the operation collar 5a, that is, above the revolver 5 and on the back side. The finger hooking part 110 includes a body part 110a that is concave from the microscope body 1 and thus has a concave shape and the front side of the body part 110a serves as a finger hook surface 110b. The depth of the concave of the finger hooking part 110 from the microscope body 1 is preferably a length that enables other fingers to be hooked, for example, 5 mm or larger. Furthermore, the length of the concave is preferably 50 mm or large and the width of the concave is preferably 15 mm or larger such that the tips of other fingers enter the concave.

The finger hooking part 110 is preferably provided on both the left and right of the microscope body 1 when viewed from the observer and the finger hooking part 110 and its vicinity preferably have a color different from those of the microscope body 1 and the operation collar 5a.

In the upright microscope 200 according to the second embodiment, the finger hooking part 110 is arranged on a part of the microscope body 1 on which, when the thumb is placed on the operation part 5b with the elbow putting on the top of a desk, other fingers are positioned and thus it is possible to operate the operation collar 5a without fail while reducing tiredness of the observer. Furthermore, the finger hooking part 110 has a concave shape and is colored in a color different from that of the microscope body 1 and accordingly operations, particularly, blind operations are much easier relying on the shape and color.

In the upright microscope according to the disclosure, the hand hooking part on which any of the fingers of the observer other than the thumb are placed when the operation collar is rotated is provided near the operation collar of the revolver and this makes it easy to switch the objective lens and reduce tiredness of the observer.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An upright microscope comprising:
a stage on which a specimen is placed;
a revolver configured to hold a plurality of objective lenses and enable each objective lens on an observation optical axis to be switched by rotating an operation collar;
a lens barrel including an optical system configured to cause light that is focused by the objective lens on the observation optical axis to be incident on eyepieces;
a microscope body including a base, a stand that stands on a back side of the base and that holds the stage, and an arm that is supported by the stand, that extends toward a font side of the upright microscope, and that includes a top part to which the lens barrel is attached and a bottom part to which the revolver is attached; and
a finger hooking part that is positioned between the revolver and a lower part of the lens barrel and that is for placing any of hand fingers other than a thumb of an observer when rotating the operation collar.

2. The upright microscope according to claim 1, wherein the finger hooking part protrudes from the microscope body and thus has a protruding shape.

3. The upright microscope according to claim 1, wherein the finger hooking part is concave from the microscope body and thus has a concave shape.

4. The upright microscope according to claim 1, wherein the finger hooking part has a surface on which hand fingers are placed and that has a smooth irregular shape.

5. The upright microscope according to claim 1, wherein the finger hooking part is positioned between the revolver and the arm and that is positioned on at least one side of right and left sides of the upright microscope.

6. The upright microscope according to claim 1, wherein the hand hooking part is detachable from the upright microscope and a distance from the operation collar to the hand hooking part is changeable.

7. The upright microscope according to claim 1, wherein
the revolver is an outward revolver that is attached to the arm such that the objective lenses are directed to the font side, and
the operation collar includes: a cylindrical part that is positioned on a side of the arm and has a cylindrical shape; and a conical part that is positioned on a side of the objective lenses and that has a conical trapezoidal shape.
